(19) United States
(12) Patent Application Publication
(10) Pub. No.: US 2015/0114353 A1
(43) Pub. Date: Apr. 30, 2015

(54) INJECTION NOZZLE

(71) Applicant: Caterpillar Motoren GmbH & Co. KG, Kiel (DE)

(72) Inventors: Andreas Von Der Osten-Sack, Kiel (DE); Ole Ohrt, Beringstedt (DE)

(73) Assignee: Caterpillar Motoren GmbH & Co. KG, Kiel (DE)

(21) Appl. No.: 14/404,841

(22) PCT Filed: May 21, 2013
(86) PCT No.: PCT/EP2013/001499

§ 371 Date: Dec. 1, 2014

(30) Foreign Application Priority Data
Jun. 5, 2012 (EP) 12170843.2

(51) Int. Cl. F02M 61/14; F02M 61/18

(52) U.S. Cl. CPC F02M 61/14; F02M 61/18
USPC 123/470

(57) ABSTRACT

An injection nozzle is disclosed. The injection nozzle may have a sealing face providing a sealed connection to the nozzle holder. The injection nozzle may also have a needle guiding bore. The needle guiding bore may have a nozzle holder section extending through the sealing face. The needle guiding bore may further have an injection side section fluidly connected to an outside of the injection nozzle via a plurality of nozzle spray holes. The needle guiding bore may also have a high pressure fuel chamber disposed between the nozzle holder section and the injection side section. The injection nozzle may also have a high pressure supply bore extending through the sealing face and fluidly and connect an opening in the sealing face with the high pressure fuel chamber via an extension.

### TECHNICAL FIELD

The present disclosure generally refers to fuel injection systems of internal combustion engines and more particularly to injection nozzles of such fuel injection systems.

### BACKGROUND

The operation of internal combustion engines with alternative fuels may result in strong wear of those components of the fuel injection systems that are in contact with the alternative fuel. Specifically, fuel injection systems may be affected by the increased cavitation activity caused by an increased water content of alternative fuels.

Alternative fuels include, for example, first generation biofuels (for example: palm oil, canola oil, oils based on animal fat) and second generation biofuels (for example: oils made of non food corps, i.e. waste biomass). Examples of second generation biofuel include “pyrolysis oils” obtained from the pyrolysis of, for example, wood or agricultural wastes, such as the stalks of wheat or corn, grass, wood, wood shavings, grapes, and sugar cane. In particular, alternative fuels may have an increased water content of, for example, <26% by volume as it may be the case for pyrolysis oils and ethanol based fuels as described in the European patent application EP 12 157 275.4 filed on 28 Feb. 2012 by Caterpillar Motoren GmbH & Co. KG.

Additionally to the operation with alternative fuels, fuel injection systems may also be configured for interchanging operation with conventional fuels, including diesel fuels (DFO), light fuel oil (LFO), heavy fuel oil (HFO), or low and high sulphur fuels. Thus, generally, the fuel injection systems may come in contact with a large variety of types of fuels at various temperatures and pressures.

The chemical composition and the physical properties of alternative fuels such as pyrolysis oils and of low-sulphur fuels can differ significantly from those of DFO, LFO, and HFO, in particular with respect to the high content of water and oxygen, the acidic pH-value in the range around, for example, 2 to 3.5, and the rather low heating value. Moreover, alternative fuels and low-sulphur fuels can have poor or completely missing lubrication properties and usually comprise small size particles in the range of, for example, 0.1-5 μm. Also the temperature of use is generally lower for alternative fuels and low-sulphur fuels than for, for example, HFO. For example, a temperature of use of 60° C. is common for pyrolysis oils to provide a viscosity, which is suitable for fuels to be injected into a combustion chamber of an engine.

Due to the chemical composition and the physical properties of alternative fuels, alternative fuels may have an increased cavitation and corrosion activity and increase the wear of the components of the fuel system.

The use of alternative fuels in internal combustion engines affects in particular the supply of the alternative fuel to a combustion chamber. Fuel injection systems include usually an injection pump system and an injection nozzle system.

Injection pump systems may be, for example, injection pumps of conventional systems as well as common rail systems and supply fuel to the injection nozzle systems. High pressure fuel pumps using a plunger are disclosed, for example, in EP 2 339 166 A1. An example for a common rail fuel injection system is disclosed, for example, in WO 2008/027123 A1. Fuel injection systems may further comprise various high pressure components such as a high pressure pump connector, short high pressure pipes, and long high pressure pipes.

DE 1 212 352 A, GB 1 434 066 A, and GB 1 521 641 A disclose exemplary shapes of seats of a fuel injector that, for example, are configured to give good fuel flow around the seat and instantaneous and very uniform delivery.

DE 199 29 473 A1 discloses a fuel injection valve with a valve element movable in a bore of a valve body with a closure head at the combustion chamber end and a valve seal surface on the valve body end facing a combustion chamber and being for interaction with a valve seat surface facing away from the combustion chamber, the valve seal surface being spatially displaced from a high pressure fuel chamber.

Injection nozzle systems may comprise, for example, an injection nozzle, usually attached to a nozzle holder.

An example of a nozzle 110 for HFO-operation as it may be known in the art is shown in FIG. 7. Nozzle 110 includes a needle 112 and a one-piece injection nozzle body 114. Nozzle body 114 is mounted via a sleeve nut 116 to a nozzle holder 118. A high-pressure chamber 120 is formed in the center of nozzle 110 between needle 112 and nozzle body 114. Fuel supply channels (not shown) provide, for example, HFO to high-pressure chamber 120. During operation, needle 112 is moved to open a fuel path from high-pressure chamber 120 to a blind hole 122 and then through nozzle spray holes 124 into a combustion chamber (not shown). Coolant supply conduits 126 provide a coolant for a circular coolant path 128 within the tip of nozzle body 114.

The present disclosure is directed, at least in part, to improving or overcoming one or more aspects of prior systems.

### SUMMARY OF THE DISCLOSURE

According to a first aspect of the present disclosure, an injection nozzle for mounting to a nozzle holder of a fuel injection system of an internal combustion engine may comprise a sealing face for providing a sealed connection to the nozzle holder, a needle guiding bore for guiding a needle between a fuel injection state and a sealed state of the fuel injector. The needle guiding bore may extend through the sealing face and be fluidly connected, at an injection side of injection nozzle, to an outside of the injection nozzle via a plurality of nozzle spray holes. The needle guiding bore may further be widened to form a high pressure fuel chamber in a middle section of the injection nozzle. A high pressure supply bore may extend through the sealing face and fluidly connecting an opening in the sealing face with the high pressure fuel chamber, wherein a radial outer section of a wall of the fuel supply channel may smoothly transition into a wall of the high pressure fuel chamber.

According to a another aspect of the present disclosure, an injection nozzle for mounting to a nozzle holder of a fuel injection system of an internal combustion engine may comprise a sealing face for providing a sealed connection to the nozzle holder, a needle guiding bore for guiding a needle between a fuel injection state and a sealed state of the fuel injector. The needle guiding bore may extend through the sealing face and be fluidly connected, at an injection side of injection nozzle, to an outside of the injection nozzle via a plurality of nozzle spray holes. The needle guiding bore may further be widened to form a high pressure fuel chamber in a middle section of the injection nozzle. A high pressure supply bore may extend through the sealing face and fluidly connecting an opening in the sealing face with the high pressure fuel chamber, wherein the wall of the high pressure supply bore forms an extension with the respective region of the wall of the high pressure fuel chamber, and the extension is provided with a one-sided rounding at a transition from the high pressure fuel chamber into the high pressure supply bore and an edge-like shape at a transition from the high pressure fuel chamber into the needle guiding bore. According to another aspect of the present disclosure, a fuel system for an internal combustion engine may comprise a pressurized fuel supply source, and an injection system comprising an injection nozzle as described herein.

In some embodiments of the injection nozzle, an axis of the needle guiding bore may intersect with an axis of the high pressure supply bore at an angle and, at the position at which the radial outer section of the fuel supply channel opens into the high pressure fuel chamber, the wall of the high pressure fuel chamber may substantially extend under that angle with respect to the axis of the needle guiding bore. In some embodiments, a radial inner section of the wall of the high pressure supply bore may form an extension with the respective region of the wall of the high pressure fuel chamber that is, for example, rounded up.

Exemplary curvatures of the rounded extension may be in the range of 3 mm to 8 mm, for example, 5.5 mm. Exemplary angles may be in the range from 3° to 10°, for example, 5°. Exemplary minimal thicknesses of the extension may be in the range of 2 mm to 6 mm.

In some embodiments of the injection nozzle, the high pressure fuel chamber may be formed in a drop-like shape. An inner wall of the high pressure fuel chamber may be rounded in an axial direction of the injection nozzle and may have a center of curvature for the rounded inner wall that is radially positioned within a maximal radial extent of the high pressure fuel chamber. Exemplary curvatures may be a radius in the range of 5 mm to 11 mm, for example, 7.8 mm.

In some embodiments of the injection nozzle, the inner wall of the high pressure fuel chamber may change curvature when transitioning into an injection side section of the needle guiding bore. In a radial direction of the high pressure fuel chamber, the high pressure supply bore may open into the high pressure fuel chamber at an outermost radial extent of the high pressure fuel chamber such that the outer radial position of the high pressure supply bore, when transitioning into the high pressure fuel chamber, corresponds to the outer radial position of the high pressure fuel chamber.

In some embodiments, the injection nozzle may be configured for operation with fuel having a temperature that does not require cooling of the injection nozzle. The injection nozzle may be an uncooled injection nozzle, for example, without a cooling fluid connection from a nozzle holder side of the injection nozzle to its injection side.

In some embodiments, the absence of steps within a fuel flow and/or of forced fuel flow around corners may reduced the cavitation activity during operation of the fuel system and in particular the respective component may, thereby, extend the component's and thus the fuel system's lifetime.

Other features and aspects of this disclosure will be apparent from the following description and the accompanying drawings.

### BRIEF DESCRIPTION OF THE DRAWINGS

FIG. 1 is a side view of a schematically isolated fuel injection system for an internal combustion engine;

FIG. 2 is a top view of the schematically isolated fuel injection system of FIG. 1;

FIG. 3 is a side view of an injection nozzle;

FIG. 4 is a top view of the injection nozzle of FIG. 3;

FIG. 5 is a cut view of the injection nozzle of FIG. 3 along line V-V indicated in FIG. 3; and

FIG. 6 is a cut view of the injector nozzle of FIG. 3 along line VI-VI indicated in FIG. 4.

### DETAILED DESCRIPTION

The following is a detailed description of exemplary embodiments of the present disclosure. The exemplary embodiments described therein and illustrated in the drawings are intended to teach the principles of the present disclosure, enabling those of ordinary skill in the art to implement and use the present disclosure in many different environments and for many different applications. Therefore, the exemplary embodiments are not intended to be, and should not be considered as, a limiting description of the scope of patent protection. Rather, the scope of patent protection shall be defined by the appended claims.

The present disclosure is based on the realization that engines operated with fuels, which may have an increased cavitation activity, may be prone to a shortening of the lifetime of respective components of the fuel injection system due to increased surface wear and damaging. An increase in surface wear may be in particular the case for components when the fuel is pressurized and/or guided around corners. Initially the surface may be damaged on a micro-scale whereby the damages may then increase to fractions of the component. Once a surface is damaged, corrosive features of fuels may add to shortening the components lifetime.

The present disclosure is further based on the realization that in fuel guiding components cavitation may occur. Specifically, when pressurized fuel may be redirected or a pressurized fuel flow is confronted with a corner formed by fuel guiding channels, cavitation may occur downstream of the respective corner. This may be the case for fuel components such as injection nozzles of fuel injection systems. It was further realized that, in order to reduce the vulnerability to cavitation, one may adjust the component's geometry and, for example, remove any protruding corner or step-like geometry from the fuel path.

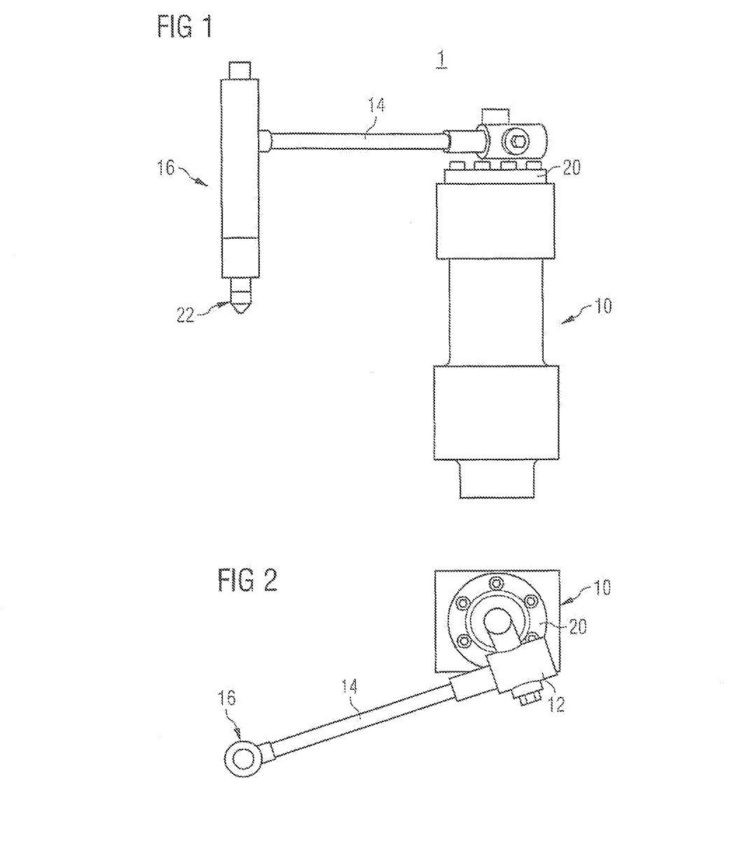

In FIG. 1 and FIG. 2, a general fuel injection system 1 for an internal combustion engine is shown as a side view and as a top view, respectively. Fuel injection system 1 may comprise a high pressure fuel pump 10, a short high pressure pipe 12, a long high pressure pipe 14, and an injection system 16. In such a system, fuel may be pressurized in high pressure fuel pump 10 and provided to the injection system 16. Specifically, high pressure fuel pump 10 may comprise a valve carrier 20 for connecting to high pressure pipes 12 and 14 and providing the pressurized fuel to an injection nozzle 22 of injection system 16.

Injection system 16 may be used for internal combustion engine systems that may include, for example, an engine with a cam injection pump for a conventional pump-line-nozzle injection (as indicated in FIGS. 1 and 2) or an engine with a common rail injection, which can be operated more flexible, e.g., adjust an injection pressure, a rail pressure, the injection timing, the number and type of injections (for example, pre- and post-injections).

The internal combustion engine system may include a reservoir for an alternative fuel such as pyrolysis oil and an internal combustion engine. The internal combustion engine may be configured to operate, for example, with a mixture of the pyrolysis oil. Alternatively or additionally, internal combustion engine may be configured to operate, for example, with an alternative fuel as disclosed, for example, in PCT patent application publication WO 2011/120542 A1 filed on 1 Apr. 2010 by Caterpillar Motoren GmbH & Co. KG or a switching fuel as disclosed, for example, in European patent application EP 12 157 275.4 filed on 28 Feb. 2012 by Caterpillar Motoren GmbH & Co. KG.

Injection system 16 may be supplied with pressurized alternative fuel by fuel injection pump 10 and may be configured to spray, for example, a mixture of the fuel such as pyrolysis oil into the combustion chamber via injection nozzle 22.

The number of fuel injection pumps, injection systems, and combustion chambers of the internal combustion engine may not specifically be restricted. For example, a stationary or mobile power system may include for inline configurations 4, 6, 7, 8, 9, or 10 combustion chambers with one or more associated fuel injection pumps and respective nozzle systems, while a V-configuration of an internal combustion engine may include 12, 14, 16, 18, or 20 combustion chambers with one or more fuel injection pumps and respective nozzle systems.

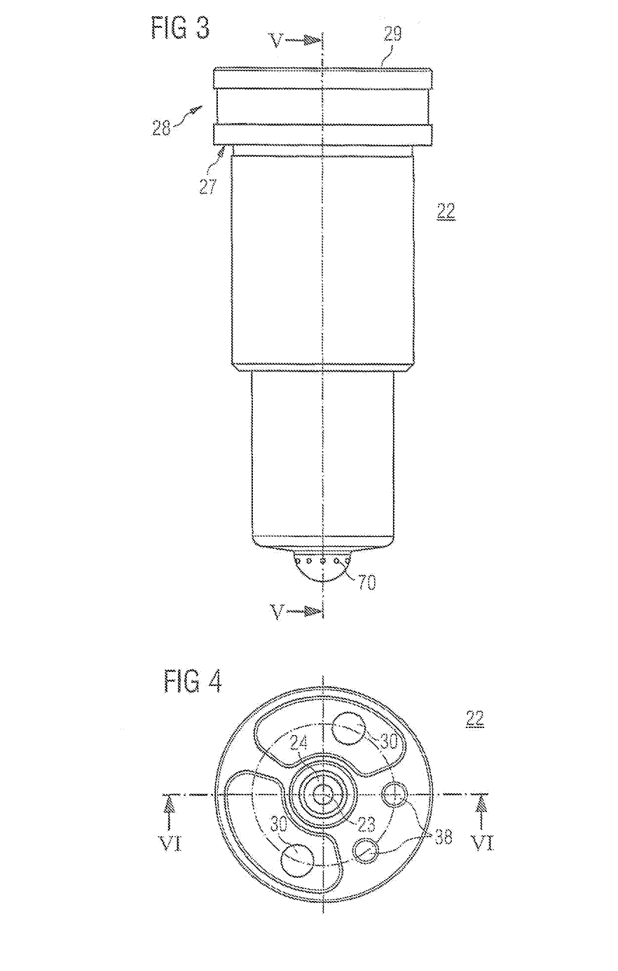

FIG. 3 shows a side view and FIG. 4 a top view of an exemplary embodiment of an injection nozzle 22 adapted for injecting alternative fuel such as pyrolysis oil into a combustion chamber. Injection nozzle 22 may be essentially rotational symmetrical with respect to a longitudinal axis 23 with the exception of the fuel supply lines and the mounting holes.

To mount injection nozzle 22, a mount (not shown) may interact with a nozzle holder (not shown), for example, via a thread connection. The mount may be configured to pull injection nozzle 22 towards the nozzle holder. For example, the mount may be a one-sided threaded nut such as a sleeve nut acting onto a mount contact face 27 of a collar 28 of injection nozzle 22.

If the mount is moved towards the nozzle holder, injection nozzle 22 may contact the nozzle holder at first at a sealing face 29 at the nozzle holder side of injection nozzle 22. Applying a force onto collar 28 towards the nozzle holder may allow forming a seal by tightly contacting sealing face 29 with an opposing surface of the nozzle holder.

As shown in FIG. 4's top view of nozzle 22, two blind holes 30 may be provided to interact with bolts of the nozzle holder and ensure the proper relative position between injection nozzle 22 and the nozzle holder.

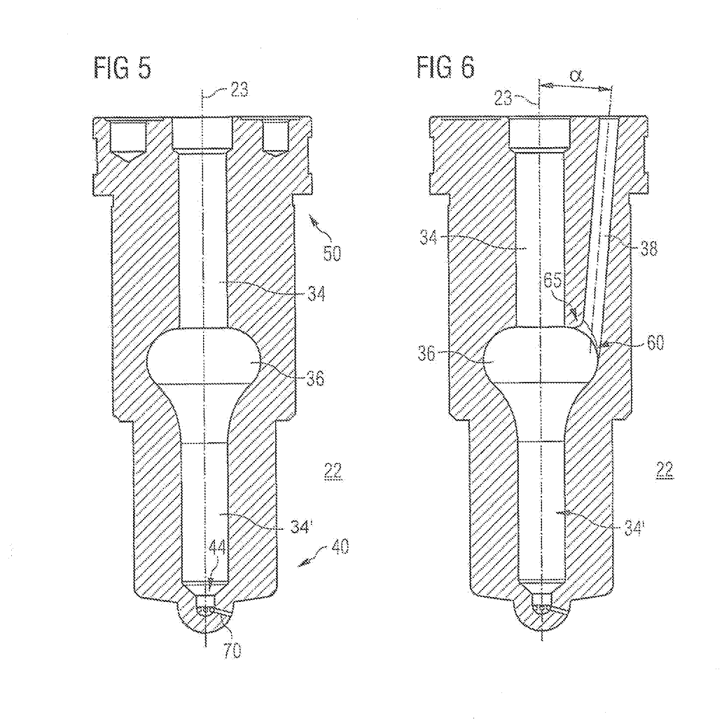

Referring to FIGS. 5 and 6, injection nozzle 22 may be configured to guide a needle (not shown) within a bore 34 of injection nozzle 22. The needle may be movable along bore 34 and be guided within injection nozzle 22 between a fuel injecting (open) state and a sealed (closed) state of injection system 16.

Bore 34 may be shaped to form a high pressure fuel chamber 36 between the needle and injection nozzle 22. High pressure chamber 36 may be centrally located in axial direction within injection nozzle 22. High pressure chamber 36 may be supplied via, for example, one, two or more high pressure supply bores with pressurized fuel. As an example, two high pressure supply bores 38 are shown in FIG. 3, one of which is also shown in the cut view of FIG. 6.

In the mounted state, high pressure supply bores 38 may be fluidly connected to corresponding high pressure supply conduits extending within the nozzle holder. The nozzle holder's high pressure supply conduits may be connected with sources of pressurized fluids such as the alternative fuel that are usually provided by fuel injection system 1 of FIGS. 1 and 2.

An injection side section 34′ of bore 34 and the needle (not shown) may be configured to provide a high pressure fuel path from high pressure chamber 36 to a valve seat 44. At the injection side, the opening of valve seat 44 of injection nozzle 22 may be sealed by the tip of the needle, thereby controlling the injection of the, for example, alternative fuel.

Fuel injection system 1 may be configured to control operation of the injection nozzle system. Specifically, the nozzle holder and/or a pump control system (not shown) may include elements configured to open and/or close the valve that is formed at an injection side 40 of injection nozzle 22. The valve may comprise valve seat 44 of injection nozzle 22 that may interact with the tip of the needle.

In a conventional pump-line-nozzle injection system, for example, a spring (not shown) may provide the force that acts via a stud onto the needle to close the valve by pressing the needle onto the valve seat thereby sealing an opening within valve seat 44. In contrast, in a common rail injection pump system, the force may be applied by a pressurized hydraulic, for example, electrically controlled system.

Referring to FIG. 6, high pressure supply bores 38 may extend at an angle a with respect to longitudinal axis 23 of injection nozzle 22. For example, high pressure supply bores 38 may extend at an angle smaller than 10°, for example, 9°, 7°, 5.5°, or 4° with respect to longitudinal axis 23.

Depending on the angle of high pressure supply bore 38, the thickness of the material provided between high pressure supply bores 38 and bore 34 (indicated in FIG. 6 as extension 65) may be selected. In some embodiments, the maximal radial extent of high pressure chamber 36 may be selected by the angle of high pressure supply bore 38 and the axial position of high pressure chamber 36. The maximal radial extent of high pressure chamber 36 may be in the range from 18 mm to 31 mm, for example, 26.5 mm. The axial extent of high pressure chamber 36 may be in the range from 15 mm to 36 mm, for example, 27.5 mm.

As shown in FIG. 6, at extension 65, the transition of pressure supply bore 38 to high pressure chamber 36 is provided with a one-sided rounding that smoothens the transition from pressure supply bore 38 into high pressure chamber 36. That one-sided rounding may reduce any material stress and may have a range of possible radii from 0.5 mm to 6 mm, for example 2 mm, 3 mm, or 5.5 mm. The rounding is only applied at the radial outer side of extension 65 and not at the radial inner side, which is the transition to bore 34.

A circular cross-section of pressure supply bore 38 may result in a specific geometrical shape (for example, an—with respect to the axis of pressure supply bore 38—tilted and additionally slightly deformed ellipse) when pressure supply bore 38 opens into high pressure chamber 36. The radial inner side of specific geometrical shape may be provided with a radius as discussed above, while the radial outer side may provide a smooth, for example, tangential transition (corresponding to “no” rounding) into high pressure chamber 36 as discussed herein. The corresponding cut view is shown in FIG. 6. Depending on, for example, the relation between the diameter of pressure supply bore 38 and the diameter of high pressure chamber 36 as well as on the manufacturing method, the opening into high pressure chamber 36 may transition from the no rounding to a maximum rounding at the radial inner position in a case specific manner.

The proposed one-sided rounding may reduce the cavitation formation when fuel enters high pressure chamber 36, which is of advantage as the cavitation formation may in particular be a reason for structural instability during operation of injection nozzle 22 at the radial inner side.

As shown in FIG. 6, on the radial inner side, the transition to bore 34 is formed as an edge, which is formed to be sharp-cornered and unrounded in comparison to the one-sided rounding. The edge-like shape at the transition from high pressure fuel chamber 36 into needle guiding bore 34 may reduce any negative influence to the fuel leakage, forced by, for example, capillary action. Therefore, a (large) radius in this intersection is avoided out of the manufacture processing in that transition.

The shape of extension 65 with the one-sided rounding and the edge-like shape on the inner side—such as shown in FIG. 6—provide on the radial inner side (next to bore 34) a tight sealing with respect to the therein guided needle, thereby reducing, for example, the risk of cavitation induced stress fracture. Moreover, the one-sided rounding reduces the dead volume for the fuel between the needle and extension 65, which would be available at a two-sided.

In contrast, the sealing of the needle may be reduced in case of a two-sided rounding, for example, through to a funnel effect causing a capillary entry into the upper section of bore 34. In addition, an angularly restricted two-sided rounding may cause a hydraulic decentralization of the needle which would increase the leakage further.

In FIG. 6, the cut view of injection nozzle 22 along the line VI-VI shown in FIG. 4 illustrates the position of high pressure chamber 36 to be at about 50% of the axial length of injection nozzle 22 and angle a of high pressure supply bore 38 with respect to longitudinal axis 23 to be about 5.5°. For that case, the minimal thickness of extension 65 may be, for example, in the range from 2 mm to 6 mm, for example, 4 mm.

In some embodiments, extension 65 may transition into high pressure supply bore 38 smoothly with a radius curvature of, for example 2 mm, 3 mm, or 5.5 mm as schematically indicated in the cut view FIG. 6 for the radial inner position.

The opening of high pressure supply bore 38 into high pressure chamber 36 may further be configured such that there is a smooth transition of the inner wall of high pressure supply bore 38 into the inner wall of high pressure chamber 36.

For example, high pressure chamber 36 may be shaped in a pear-like (drop-like) configuration having its thick end at a nozzle holder side 50 of injection nozzle 22 and its thin end at injection side 40. Specifically, high pressure chamber 36 may have a rounded wall with a radius of the rounding at nozzle holder side 50 in the range from 5 mm to 11 mm, for example, 7.75 mm. The curvature of the rounded wall then may reverse at injection side 40 from a radius of 10 mm to a radius of 25 mm, thus smoothly transitioning into injection side section 34′ of bore 34. Herein, smoothly transitioning may be provided, for example, if there is none or only a small step or small change in curvature.

In the embodiment of FIG. 6, high pressure supply bore 38 may have a radial outer section 60 of its wall at the radial position of the radial outer section of high pressure chamber 36. In some embodiments, radial outer section 60 of the wall of high pressure supply bore 38 may extend as a tangent to the wall of high pressure chamber 36, thus smoothly transitioning into high pressure chamber 36.

In the embodiments disclosed herein, when pressurized fuel is provided to high pressure chamber 36, the flow of the pressurized fuel may be subjected not at all to corners along its flow path and instead only to smooth changes in curvature of the wall structure.

At injection side 40, spray holes 70 (in number 1 to 20, for example, 11) having a diameter of, for example, about 0.55 mm to 2.6 mm may fluidly connect injection side section 34′ of bore 34 to the outside (which ism in the mounted state, the inside of the combustion chamber).

In some configurations, the use of alternative fuels, which may be supplied at a relatively low temperature of about, for example, 60° C. in contrast to HFO supplied at, for example, 150° C., may avoid the necessity of a cooling channels extending to the tip of injection nozzle 22. The lack of cooling channels may allow moving high pressure chamber to about 50% of the axial length of injection nozzle or even closer to spray holes 70. The embodiments disclosed in connection with FIGS. 3 to 6 show an example of an uncooled injection nozzle.

### INDUSTRIAL APPLICABILITY

The features and embodiments of the structural configuration of the injection nozzle explained in connection with FIGS. 3 to 6 may reduce alone or in combination disadvantageous effects caused by cavitation during operation of the injector.

In general injection nozzle 22 may be dimensioned such that it does not deform when pressurized fuel may be supplied into high pressure supply bores 38, high pressure chamber 36, and bore 34′.

The specific shape of high pressure chamber 36 and high pressure supply bore 38 may be made by drilling, turning, milling, grinding, and/or eroding and polishing.

The embodiments disclosed herein may provide a similar or the same outer geometry for the configuration of injection nozzle 22 than is provided by nozzle 110 of FIG. 7. Accordingly, the proposed injection nozzle may be used without further modification with operation internal combustion engines.

Exemplary materials for needle guide members and for needles include tempered tool steel and, in particular, austenitic steel, for example, cobalt-chromium steel and Nitride-Chromium Steels in addition to ceramic based materials. In addition, all or selected sections of the surfaces of the needles or needle guide members can be coated with diamond-like carbon (DLC).

Herein, the term “large internal combustion engine” may refer to internal combustion engines which may be used as main or auxiliary engines of stationary power providing systems such as power plants for production of heat and/or electricity as well as in ships/vessels such as cruiser liners, cargo ships, container ships, and tankers.

In addition, the term “internal combustion engine” as used herein is not specifically restricted and comprises any engine, in which the combustion of a fuel occurs with an oxidizer to produce high temperature and pressure gases, which are directly applied to a movable component of the engine, such as pistons or turbine blades, and move it over a distance thereby generating mechanical energy. Thus, as used herein, the term “internal combustion engine” comprises piston engines and turbines, which can, for example, be operated with alternative fuels such as pyrolysis oil or ethanol based fuels.

Examples of such engines that are suitable for adaptation to alternative fuels include medium speed internal combustion diesel engines, like inline and V-type engines of the series M20, M25, M32, M43 manufactured by Caterpillar Motoren GmbH & Co. KG, Kiel, Germany, operated in a range of 500 to 1000 rpm.

Although the preferred embodiments of this invention have been described herein, improvements and modifications may be incorporated without departing from the scope of the following claims.

1. An injection nozzle for mounting to a nozzle holder of a fuel injection system of an internal combustion engine, the injection nozzle comprising:
a sealing face for providing a sealed connection to the nozzle holder;
a needle guiding bore for guiding a needle between a fuel injection state and a sealed state of the fuel injector, the needle guiding bore, including:
a nozzle holder section extending through the sealing face;
an injection side section fluidly connected to an outside of the injection nozzle via a plurality of nozzle spray holes; and
a high pressure fuel chamber disposed between the nozzle holder section and the injection side section, the high pressure fuel chamber having an inner wall that intersects a side wall of the nozzle holder section via a sharp edge; and
a high pressure supply bore extending through the sealing face and fluidly connecting an opening in the sealing face with the high pressure fuel chamber
via an extension.

2. The injection nozzle of claim 1, wherein a first longitudinal axis of the needle guiding bore intersects with a second longitudinal axis of the high pressure supply bore at an angle (α).

3. The injection nozzle of claim 2, wherein the extension includes a rounded surface that transitions between the inner wall of the high pressure fuel chamber and a wall of the high pressure supply bore.

4. The injection nozzle of claim 3, wherein
a first section of the wall of the high pressure supply bore is disposed at a first radius relative to the first longitudinal axis,
a second section of the wall of the high pressure supply bore is disposed at a second radius relative to the first longitudinal axis, the second radius being larger than the first radius, and
a radius of curvature of the rounded surface decreases from the first section to the second section.

5. The injection nozzle of claim 4, wherein the radius of curvature of the rounded surface ranges from 0.5 mm to 8 mm at the first section.

6. The injection nozzle of claim 2, wherein the angle (α) ranges from 3° to 10°.

7. The injection nozzle of claim 2, wherein the angle (a) is selected such that a thickness of the extension ranges between 2 mm to 6 mm.

8. The injection nozzle of claim 1, wherein the high pressure fuel chamber has a drop-like shape.

9. The injection nozzle of claim 1, wherein the inner wall of the high pressure fuel chamber is rounded in an axial direction of the injection nozzle.

10. The injection nozzle of claim 9, wherein a center of curvature for the inner wall is radially positioned within the high pressure fuel chamber and the inner wall has a radius of curvature in the range of 5 mm to 11 mm.

11. The injection nozzle of claim 10, wherein the radius of curvature is a first radius of curvature and the inner wall of the high pressure fuel chamber is connected to injection side section via a transition that has a second radius of curvature different from the first radius of curvature.

12. The injection nozzle the second radius is about equal to a maximum radius of the high pressure fuel chamber relative to the first longitudinal axis.

13. The injection nozzle of claim 1, wherein the injection nozzle his configured for operation with fuel having a temperature that does not require cooling of the injection nozzle.

14. The injection nozzle of claim 1, wherein the injection nozzle is an uncooled injection nozzle.

15. A fuel system for an internal combustion engine, the fuel system comprising:
a pressurized fuel supply source; and
an injection nozzle, comprising:
a sealing face for providing a sealed connection to the nozzle holder;
a needle guiding bore for guiding a needle between a fuel injection state and a sealed state of the fuel injector, the needle guiding bore, including:
a nozzle holder section extending through the sealing face;
an injection side section fluidly connected to an outside of the injection nozzle via a plurality of nozzle spray holes; and
a high pressure fuel chamber disposed between the nozzle holder section and the injection side section, the high pressure fuel chamber having an inner wall that intersects a side wall of the nozzle holder section via a sharp edge; and
a high pressure supply bore extending through the sealing face and fluidly connecting an opening in the sealing face with the high pressure fuel chamber via an extension.

16. The fuel system of claim 15, wherein, a first longitudinal axis of the needle guiding bore intersects with a second longitudinal axis of the high pressure supply bore at an angle (α).

17. The fuel system of claim 15, pump of claim 14, wherein the extension includes:
a first section of the wall of the high pressure supply bore connected to the inner wall of the high pressure fuel chamber via a rounded surface; and
a second section of the wall of the high pressure supply bore connected to the inner wall of the high pressure fuel chamber via a surface disposed tangential to the inner wall.

18. The fuel system of claim 15, wherein wherein the injection nozzle further comprises a valve seat adjacent the nozzle spray holes, the valve seat being configure to interact with a tip of the needle.

19. The fuel system of claim 15, wherein a center of curvature for the inner wall is radially positioned within the high pressure fuel chamber and the inner wall has a radius of curvature in the range of 5 mm to 11 mm.

20. The fuel system of claim 16, wherein the angle (α) ranges from 3° to 10°.
